(19) United States
(12) Patent Application Publication
(10) Pub. No.: US 2024/0290356 A1
(43) Pub. Date: Aug. 29, 2024

(54) APPARATUS FOR GENERATING CROSS-EDITED VIDEO AND METHOD OF OPERATING THE APPARATUS

(71) Applicant: Korea Advanced Institute of Science and Technology, Daejeon (KR)

(72) Inventors: Junyong NOH, Daejeon (KR); Dawon LEE, Daejeon (KR); Jung Eun YOO, Daejeon (KR); Kyungmin CHO, Daejeon (KR); Bumki KIM, Daejeon (KR); GyeongHun IM, Daejeon (KR)

(21) Appl. No.: 18/586,642

(22) Filed: Feb. 26, 2024

(30) Foreign Application Priority Data
Feb. 27, 2023 (KR) 10-2023-0025788

(51) Int. Cl. G11B 27/031; G06V 20/40; G06V 40/16; G11B 27/10

(52) U.S. Cl. CPC G11B 27/031; G06V 20/46; G06V 20/49; G06V 40/171; G11B 27/10

(57) ABSTRACT

Disclosed is an apparatus for generating a cross-edited video and a method of operating the apparatus. The method includes: obtaining a plurality of videos; sequentially generating video pieces such that one of the plurality of videos is played according to a timeline, based on a first transition reward that is based on a similarity between a video before a transition and a video after the transition in a specific frame and a continuous play time and on a second transition reward that is based on an elapsed time from a previous transition point; and generating a cross-edited video by connecting the video pieces.

### CROSS-REFERENCE TO RELATED APPLICATIONS

This application claims the benefit under 35 USC § 119(a) of Korean Patent Application No. 10-2023-0025788 filed on Feb. 27, 2023, in the Korean Intellectual Property Office, the entire disclosure of which is incorporated herein by reference for all purposes.

### BACKGROUND

### 1. Field of Invention

The following description relates to an apparatus for generating a cross-edited video and a method of operating the apparatus.

### 2. Description of Related Art

As a type of popular video content provided through social networking services (SNS) and the like, videos obtained by mixing and editing videos with the same sync recorded for the same artist in different times and environments are provided. As a general example, videos generated by cross-connecting stage performances of K-pop music artists are provided.

These videos may be generated in consideration of a method for a transition at a point in time at which videos are crossed. Typically, when creating a video, a creator of the video determines a transition point of an input video and applies a transition effect to the transition point to create a softening effect that allows the silhouettes of an object in images to match each other.

However, creating such a video by a creator themselves may require a great amount of time. The entire process relies on the discretion of the creator—for example, the creator needs to compare all the videos used at the frame level—and there may be various trials and errors in the transition of the videos.

### SUMMARY

According to an example embodiment of the present disclosure, there is provided a method of operating an apparatus for generating a cross-edited video, the method including: obtaining a plurality of videos; sequentially generating video pieces such that one of the plurality of videos is played according to a timeline, based on a first transition reward that is based on a similarity between a video before a transition and a video after the transition in a specific frame and a continuous play time and on a second transition reward that is based on an elapsed time from a previous transition point; and generating a cross-edited video by connecting the video pieces.

The first transition reward may be based on the similarity that is calculated based on an overlap between feature points extracted from consecutive frames before and after the specific frame.

The feature points may be extracted from the plurality of videos in a unit of frame and may include at least one portion of a face region of an object included in a unit frame.

The first transition reward may be calculated as a product of a reward that is preset according to a play time of the video before the transition in the specific frame and a reward that is based on the similarity.

The second transition reward may be expressed as a negative value based on the elapsed time from the previous transition point.

The sequentially generating of the video pieces such that one of the plurality of videos is played according to the timeline may include sequentially generating the video pieces based on one of the first transition reward and the second transition reward.

The sequentially generating of the video pieces may include: when the similarity exceeds a preset threshold, selecting a corresponding video piece from among the plurality of videos based on the first transition reward; and when the similarity does not exceed the threshold but exceeds a preset continuous play time, selecting a corresponding video piece from among the plurality of videos based on the second transition reward.

The obtaining of the plurality of videos may include extracting a feature point in a unit of frame from each of the plurality of videos.

The generating of the cross-edited video by connecting the video pieces may include overlapping a plurality of frames before and after the specific frame of the generated video pieces; and generating a transition effect on the overlapping frames.

The generating of the cross-edited video by connecting the video pieces may include overlapping frames of the video before the transition and the video after the transition based on a feature point with the similarity in the specific frame; and cutting edges of the overlapping frames of the video before the transition and the video after the transition based on a scale of the cross-edited video.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a method of generating a cross-edited video according to an example embodiment;

FIG. 2 is a flowchart illustrating a method of operating an apparatus for generating a cross-edited video according to an example embodiment;

FIG. 3 is a diagram illustrating a method of generating video pieces included in a cross-edited video according to an example embodiment;

FIGS. 4A and 4B are diagrams illustrating a method of calculating a first transition reward for a video transition according to an example embodiment;

FIGS. 5A and 5B are diagrams illustrating a method of connecting video pieces according to an example embodiment;

FIG. 6 is a diagram illustrating a method of processing an edge margin between video pieces according to an example embodiment; and

FIG. 7 is a diagram illustrating a configuration of an apparatus for generating a cross-edited video according to an example embodiment.

### DETAILED DESCRIPTION

Hereinafter, example embodiments of the present disclosure will be described in detail with reference to the accompanying drawings. The following structural or functional descriptions of embodiments described herein are merely intended for the purpose of describing the embodiments described herein and may be implemented in various forms. However, it is to be understood that these embodiments are not construed as limited to the illustrated forms.

The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

In addition, when describing the example embodiments with reference to the accompanying drawings, like reference numerals refer to like components and a repeated description related thereto will be omitted. In addition, when describing the example embodiments, a detailed description of related known technology that is deemed to unnecessarily obscure the gist of the example embodiments will be omitted.

Although terms such as “first” and “second” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in the examples described herein may also be referred to as a second member, component, region, layer, or section without departing from the teachings of the examples. Throughout the specification, when an element is described as “connected to” or “coupled to” another element, it may be directly “connected to” or “coupled to” the other component, or there may be one or more other components intervening therebetween. In contrast, when an element is described as “directly connected to” or “directly coupled to” another element, there can be no other elements intervening therebetween.

In addition, components included in one example embodiment and components including the same or common functions will be described using the same names in other example embodiments. Unless otherwise stated, the description given in one example embodiment may be applied to other example embodiments, and repeated descriptions thereof will be omitted.

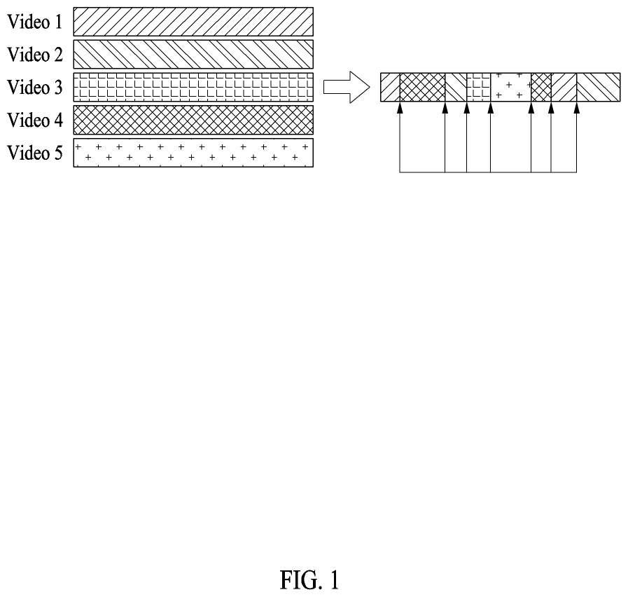

FIG. 1 is a diagram illustrating a method of generating a cross-edited video according to an example embodiment.

According to an example embodiment, a cross-edited video may be generated by alternately mixing a plurality of videos with the same sync into a single video. For example, a plurality of videos having the same sync may correspond to a plurality of videos in which stage performances are filmed for the same song. Video pieces generated from the plurality of videos may be connected to each other. The plurality of videos may have different numbers of frames to be played per second.

To generate a single cross-edited video, video pieces representing different syncs from a plurality of videos may be connected into a single video. The video pieces may each be generated to be several seconds long.

According to an example embodiment, the cross-edited video may be generated through dynamic programming, and the guidelines for generating a cross-edited video through dynamic programming will be described hereinafter.

The video pieces of the cross-edited video may each be generated not to exceed a preset minimum play time and a preset maximum play time.

The video pieces may be edited using a region of interest (ROI) to direct a view of a user toward a specific direction. The video pieces may be generated using a transformation technology for cropping, rotating, and resizing frames to most desirably include an ROI.

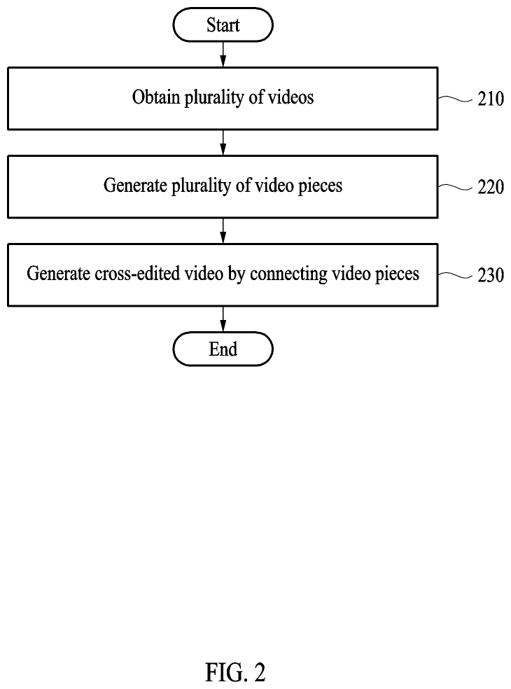

FIG. 2 is a flowchart illustrating a method of operating an apparatus for generating a cross-edited video according to an example embodiment.

In operation 210, the apparatus may obtain a plurality of videos.

The apparatus may obtain a plurality of videos having the same sync and extract a feature point in a unit of frame included in the videos. For example, as described above with reference to FIG. 1, the plurality of videos may include a plurality of videos in which different stage performances are filmed for the same song.

The feature point may include, for example, at least one part of a human face. The feature point may be used as a reference to generate video pieces and connect the generated video pieces.

In operation 220, the apparatus may generate a plurality of video pieces.

For the plurality of videos, a transition of video piece may be performed on a specific frame. In this case, for example, the apparatus may generate the video pieces based on a first transition reward that is based on a similarity between a video before the transition and a video after the transition and a play time and on a second transition reward that is based on an elapsed time from a previous transition point.

For example, the similarity between the video before the transition and the video after the transition may be determined based on the first transition reward. The first transition reward may be determined by calculating the similarity using the feature point previously extracted as described above, and adding a preset reward to the calculated similarity or multiplying the similarity by the preset reward according to a continuous play time.

The second transition reward may be used when the similarity based on the first transition reward in the specific frame is calculated below a certain level and a frame suitable for the transition is not found based on the similarity.

A maximum play time for playing a video piece in a cross-edited video may be determined in advance, and the video pieces may be sequentially generated according to a timeline, each within the maximum play time, based on the first transition reward or the second transition reward. The first transition reward may be set to a positive value, and the second transition reward may be set to a negative value.

In operation 230, the apparatus may generate a cross-edited video by connecting the video pieces.

The video pieces generated based on the first transition reward and the second transition reward may be connected to each other by a transition effect.

For example, video pieces generated based on a high similarity in a specific frame may be connected through a matching-based transition (MBT) effect through which the video pieces are edited using the transition effect for a plurality of overlapping frames before and after the specific frame such that the frames become gradually blurry or clearer and, as the video pieces are edited through the MBT effect, they may provide a visually soft transition in the specific frame.

The video pieces generated based on the maximum play time may be simply connected without any special transition effects based on a frame where the video pieces are connected. This may be referred to hereinafter as a jump cut transition. According to an example embodiment, the jump cut transition may be minimized by setting the maximum play time to be long. The jump cut transition may be performed when the MBT effect is not available, and a video piece reaches its maximum play time, or when the MBT effect is subsequently required to connect video pieces.

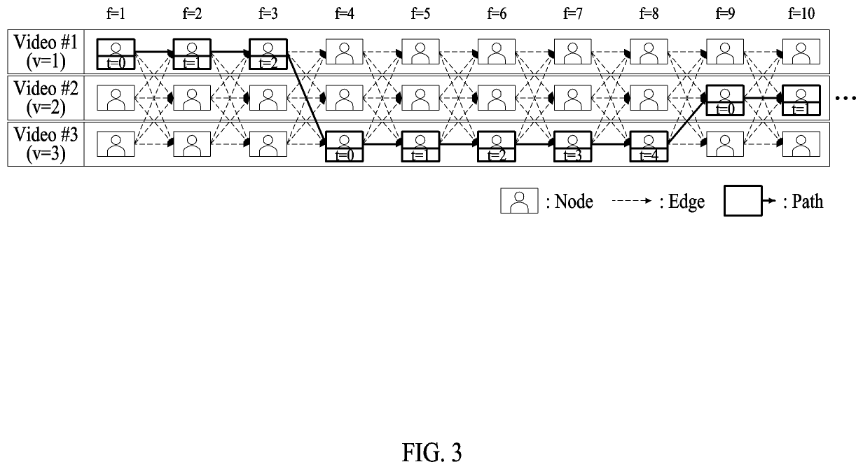

FIG. 3 is a diagram illustrating a method of generating video pieces included in a cross-edited video according to an example embodiment.

As described above, each video piece may be edited to be played within a preset maximum play time. For example, a video piece may be generated to be played desirably for 3 to 5 seconds, but up to 8 seconds. An example editing path is shown in FIG. 3. Based on a frame at which a video transition occurs, the MBT effect may be applied, or the jump cut transition may be performed.

A play time may be counted based on a point in time at which a video is played. As shown in FIG. 3, based on a start time of a video with f being 1 (e.g., f=1), a video piece corresponding to 3 seconds of video 1, a video piece corresponding to 5 seconds of video 3 from f being 4 (e.g., f=4), and a video piece of video 2 from f being 9 (e.g., f=9) may be connected.

A generated cross-edited video may be an optimal result obtained from the number of cases through dynamic programming. The number of video pieces for forming the cross-edited video may be preset, and/or a minimum play time or a maximum play time for one video piece for the cross-edited video may also be set.

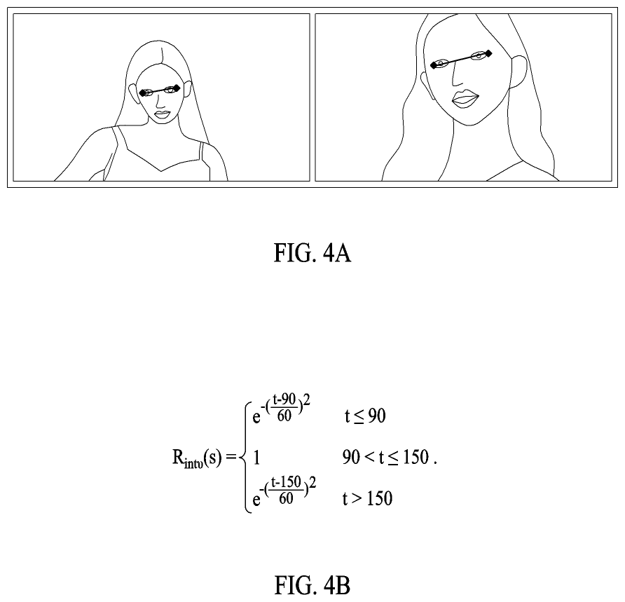

FIGS. 4A and 4B are diagrams illustrating a method of calculating a first transition reward for a video transition according to an example embodiment.

A first transition reward may be calculated using a similarity in a specific frame between a video before a transition and a plurality of videos and a reward preset according to a continuous play time of video pieces before the transition.

FIG. 4A illustrates a method of measuring a similarity between frames, and FIG. 4B illustrates an example reward according to a continuous play time of a video piece before a transition.

As shown in FIG. 4A, as described above, a feature point extracted in a unit of frame may be used to measure a similarity in a frame where video pieces are connected. Based on the feature point extracted in a unit of frame, a similarity between videos in the same frame may be measured, and a high reward may be assigned such that the video transition occurs in a frame with a high similarity. The similarity may be measured in terms of the size, rotation angle, and the like of a feature point between frames in the same timeline.

For example, when a position of eyes is extracted as a feature point, a similarity of the feature point may be measured highly even through it is not from the same person.

According to the equation shown in FIG. 4B, a reward value according to a continuous play time of a video piece before a transition may be determined in advance. The first transition reward may be determined by multiplying the reward that is based on the continuous play time and the reward that is measured based on the similarity.

The form shown in FIG. 4B may vary depending on the setting. For example, the highest reward may be assigned to a continuous play time preferred the most by a user, and a reward for a time greater than the continuous play time set by the user may be set to have a value of 1.

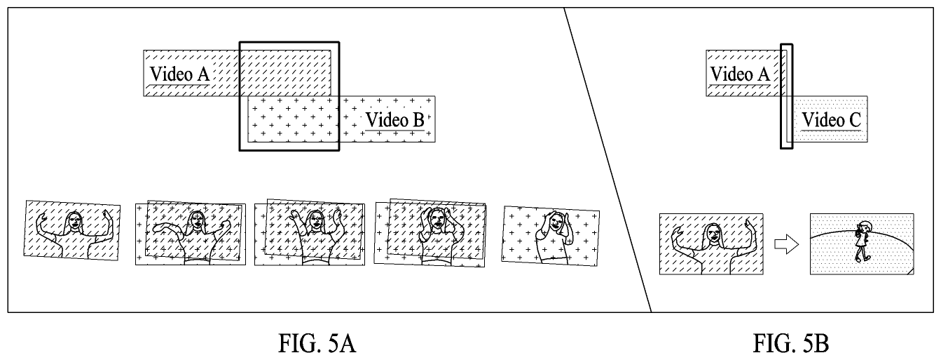

According to an example embodiment, when a specific frame for connecting video pieces is determined through the calculation of the first transition reward, a transition effect may be generated on a plurality of overlapping frames before and after the specific frame, using the MBT effect, during the video transition in the frame. The MBT effect will be described in detail below with reference to FIG. 5A.

FIGS. 5A and 5B are diagrams illustrating a method of connecting video pieces according to an example embodiment.

FIG. 5A illustrates the MBT effect described above, and FIG. 5B illustrates the jump cut transition described above.

For example, when a frame for connecting video pieces is not specified through the calculation of a first transition reward, or when a frame for connecting video pieces is found through the first transition reward after a maximum play time, the jump cut transition may be performed therebefore to connect the video pieces. During the jump cut transition, the video pieces may be connected by simply connecting frames without any special transition effects.

According to an example embodiment, a plurality of video pieces may be sequentially generated based on one of a first transition reward and a second transition reward. The first transition reward value may be represented as a positive value, and the second transition reward may be represented as a negative value based on an elapsed time from a point in time at which a video piece begins. A value may increase non-linearly until a maximum continuous play time set by a user is reached, and when the set continuous play time is reached, the value may become 0. The second transition reward may be expressed as the following equation.

$${R}_{jump} ( s ) = - {ω ( t - {t}_{jump} )}^{2} , \qquad [ Equation ]$$

The second transition reward, which is a reward calculated for the jump cut transition, may be expressed non-linearly as in the equation above. In the equation, t_jump denotes the maximum continuous play time set by the user.

For the MBT transition as shown in FIG. 5A, the apparatus may overlap a plurality of frames before and after a frame in which video pieces that are a target of connection are connected to connect video pieces in which similarity is found. For example, the video pieces may be connected using six to seven frames.

For the overlapping frames, the MBT effect may be provided to express a frame of a video piece before a transition as gradually blurry and a video after the transition as gradually clearer. To this end, to at least one of two video pieces to be connected, frames of the video pieces corresponding to the number of overlapping frames may be added.

The MBT effect may be performed based on a feature point of overlapping frames. The apparatus may overlap the frames based on the feature point in frames of each of a video piece before a transition and a video piece after the transition and provide the MBT effect. As shown, frames may be overlapped based on a feature point, and the two overlapping frames may not completely match or not be completely aligned.

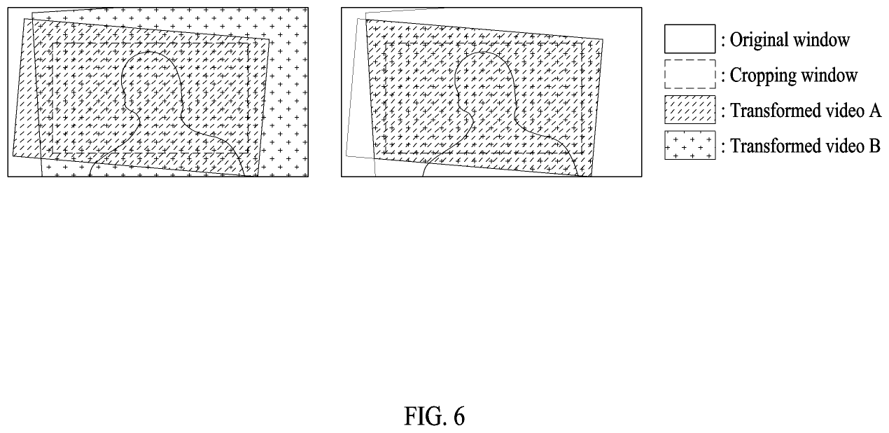

When the two frames do not match, a region that does not overlap in the overlapping frames that overlap each other based on the feature point may be cut out along the shape of the frames. This will be described in detail below with reference to FIG. 6.

As described above, the jump cut transition shown in FIG. 5B may indicate simply connecting video pieces without using a special transition effect. During the jump cut transition, a last frame of a video piece before a transition and a first frame of a video piece after the transition may simply be connected.

FIG. 6 is a diagram illustrating a method of processing an edge margin between video pieces according to an example embodiment.

When a video piece transition is performed by a first reward based on a similarity of a feature point, frames of a video before the transition and a video after the transition may be overlapped based on a feature point with the similarity in a specific frame.

The overlapping frames may have overlapping feature points and frame angles that are partially misaligned. In the case of the MBT effect, overlapping may occur on some frames based on a feature point, and it may thus be important to process a margin of the misaligned frames to prevent such margin from distracting a user or viewer from being immersed in watching.

The apparatus may cut out edges of the overlapping frames based on a scale of a cross-edited video. The apparatus may determine an optimal edge editing point by which the widest screen is obtained with a ratio of the cross-edited video maintained.

For the MBT effect, the same type of edge editing may be performed on a plurality of overlapping frames or on videos of extended length.

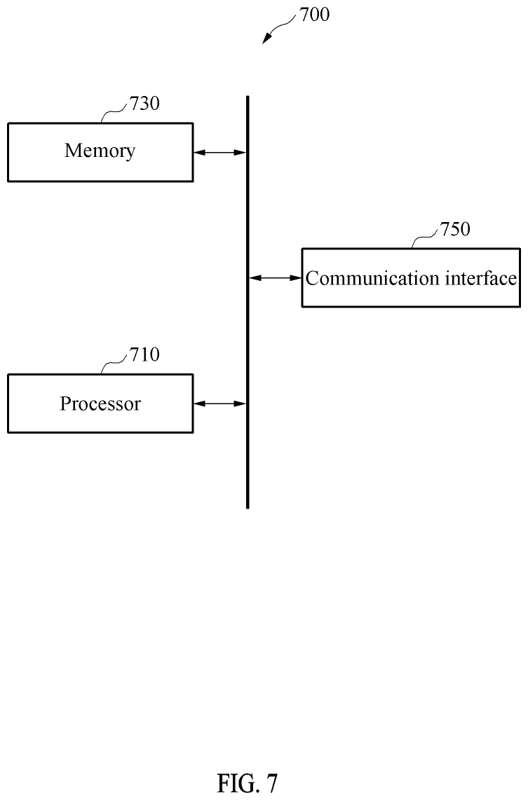

FIG. 7 is a diagram illustrating a configuration of an apparatus for generating a cross-edited video according to an example embodiment.

An apparatus 700 may include a memory 730, at least one processor 710, and a communication interface 750, and may include at least one program stored in the memory 730 and configured to be executed by the processor 710.

By the program, the apparatus 700 may determine editing points of a plurality of videos, find editing paths for the plurality of videos, and apply a transition effect to generate a cross-edited video.

According to an example embodiment, the processor 710 may execute the following operations: obtaining a plurality of videos; sequentially generating video pieces such that one of the plurality of videos is played according to a timeline, based on a first transition reward that is based on a similarity between a video before a transition and a video after the transition in a specific frame and a continuous play time and on a second transition reward that is based on an elapsed time from a previous transition point; and generating a cross-edited video by connecting the video pieces.

The memory 730 may be a volatile memory or a non-volatile memory, and the processor 710 may execute the program and control the apparatus 700. Code of the program executed by the processor 710 may be stored in the memory 730. The apparatus 700 may be connected to an external device (e.g., a personal computer (PC) or a network) through an input/output device (not shown) and may exchange data therewith. The apparatus 700 may be provided in various computing devices and/or systems, such as, for example, a smartphone, a tablet computer, a laptop computer, a desktop computer, a television (TV), a wearable device, a security system, a smart home system, and the like.

The example embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as ROM, RAM, flash memory (e.g., USB flash drives, memory cards, memory sticks, etc.), and the like. Examples of program instructions include both machine code, such as produced by a compiler, and files containing higher-level code that may be executed by the computer using an interpreter. The above-described hardware devices may be configured to act as one or more software modules in order to perform the operations of the above-described examples, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of operating an apparatus for generating a cross-edited video, the method comprising:
obtaining a plurality of videos;
sequentially generating video pieces such that one of the plurality of videos is played according to a timeline, based on a first transition reward that is based on a similarity between a video before a transition and a video after the transition in a specific frame and a continuous play time and on a second transition reward that is based on an elapsed time from a previous transition point; and
generating a cross-edited video by connecting the video pieces.

2. The method of claim 1, wherein the first transition reward is based on the similarity that is calculated based on an overlap between feature points extracted from consecutive frames before and after the specific frame.

3. The method of claim 2, wherein the feature points are extracted from the plurality of videos in a unit of frame, and
the feature points comprise at least one portion of a face region of an object comprised in a unit frame.

4. The method of claim 1, wherein the first transition reward is calculated as a product of a reward that is preset according to a play time of the video before the transition in the specific frame and a reward that is based on the similarity.

5. The method of claim 1, wherein the second transition reward is expressed as a negative value based on the elapsed time from the previous transition point.

6. The method of claim 1, wherein the sequentially generating of the video pieces such that one of the plurality of videos is played according to the timeline comprises:
sequentially generating the video pieces based on one of the first transition reward and the second transition reward.

7. The method of claim 1, wherein the sequentially generating of the video pieces comprises:
when the similarity exceeds a preset threshold, selecting a corresponding video piece from among the plurality of videos based on the first transition reward; and
when the similarity does not exceed the threshold but exceeds a preset continuous play time, selecting a corresponding video piece from among the plurality of videos based on the second transition reward.

8. The method of claim 1, wherein the obtaining of the plurality of videos comprises:
extracting a feature point in a unit of frame from each of the plurality of videos.

9. The method of claim 1, wherein the generating of the cross-edited video by connecting the video pieces comprises:
overlapping a plurality of frames before and after the specific frame of the generated video pieces; and
generating a transition effect on the overlapping frames.

10. The method of claim 1, wherein the generating of the cross-edited video by connecting the video pieces comprises:
overlapping frames of the video before the transition and the video after the transition based on a feature point with the similarity in the specific frame; and
cutting edges of the overlapping frames of the video before the transition and the video after the transition based on a scale of the cross-edited video.

11. A non-transitory computer-readable storage medium storing instructions that, when executed by a processor, cause the processor to perform the method of claim 1.

12. An apparatus for generating a cross-edited video, comprising:
at least one processor;
a memory; and
at least one program stored in the memory and configured to be executed by the processor,
wherein the program is configured to execute the following operations:
obtaining a plurality of videos;
sequentially generating video pieces such that one of the plurality of videos is played according to a timeline, based on a first transition reward that is based on a similarity between a video before a transition and a video after the transition in a specific frame and a continuous play time and on a second transition reward that is based on an elapsed time from a previous transition point; and
generating a cross-edited video by connecting the video pieces.

13. The apparatus of claim 12, wherein the first transition reward is based on the similarity that is calculated based on an overlap between feature points extracted from consecutive frames before and after the specific frame.

14. The apparatus of claim 13, wherein the feature points are extracted from the plurality of videos in a unit of frame, and
the feature points comprise at least one portion of a face region of an object comprised in a unit frame.

15. The apparatus of claim 12, wherein the first transition reward is calculated as a product of a reward that is preset according to a play time of the video before the transition in the specific frame and a reward that is based on the similarity, and
wherein the second transition reward is expressed as a negative value based on the elapsed time from the previous transition point.

16. The apparatus of claim 12, wherein the sequentially generating of the video pieces such that one of the plurality of videos is played according to the timeline comprises:
sequentially generating the video pieces based on one of the first transition reward and the second transition reward.

17. The apparatus of claim 12, wherein the sequentially generating of the video pieces comprises:
when the similarity exceeds a preset threshold, selecting a corresponding video piece from among the plurality of videos based on the first transition reward; and
when the similarity does not exceed the threshold but exceeds a preset continuous play time, selecting a corresponding video piece from among the plurality of videos based on the second transition reward.

18. The apparatus of claim 12, wherein the obtaining of the plurality of videos comprises:
extracting a feature point in a unit of frame from each of the plurality of videos.

19. The apparatus of claim 12, wherein the generating of the cross-edited video by connecting the video pieces comprises:
overlapping a plurality of frames before and after the specific frame of the generated video pieces; and
generating a transition effect on the overlapping frames.

20. The apparatus of claim 12, wherein the generating of the cross-edited video by connecting the video pieces comprises:
overlapping frames of the video before the transition and the video after the transition based on a feature point with the similarity in the specific frame; and
cutting edges of the overlapping frames of the video before the transition and the video after the transition based on a scale of the cross-edited video.
